(19) United States
(12) Patent Application Publication
(10) Pub. No.: US 2011/0270690 A1
(43) Pub. Date: Nov. 3, 2011

(54) Remote Management of Mobile Advertising Application

(75) Inventors: Gaelle Christine Martin-Cocher, Toronto (CA); Axel Ferrazzini, Brussels (BE); Suresh Chitturi, Plano, TX (US)

(73) Assignee: Research in Motion Limited, Waterloo (CA)

(21) Appl. No.: 12/771,935

(22) Filed: Apr. 30, 2010

(51) Int. Cl. G06Q 30/00

(52) U.S. Cl. 705/14.73; 707/E17.127

(57) ABSTRACT

A management object (MO) for configuring a device relative to mobile advertising service is provided. The MO may include parameters, attributes or data for use in provisioning, configuring or otherwise managing a mobile advertising client to use the mobile advertising service. The mobile advertising MO includes at least one property including: mobile advertising enabler version information, a service provider identification, advertising server identification, an advertising server access address, a supported delivery method, and an interaction code.

### BACKGROUND

As used herein, the terms “user equipment” (“UE”), “mobile station” (“MS”), and “user agent” (“UA”) might in some cases refer to mobile devices such as mobile telephones, personal digital assistants, handheld or laptop computers, and similar devices that have telecommunications capabilities. The terms “MS,” “UE,” “UA,” user device,” and “user node” may be used synonymously herein. Furthermore the terms “MS,” “UE,” “UA,” user device,” and “user node” can also refer to any component which is hardware or software (alone or in combination) that can terminate a communication session for a user. A UE might include components that allow the UE to communicate with other devices, and might also include one or more associated removable memory modules, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances.

As telecommunications technology has evolved, more advanced network access equipment has been introduced that can provide services that were not previously possible. This network access equipment might include systems and devices that are improvements of the equivalent equipment in a traditional wireless telecommunications system. Such advanced or next generation equipment may be included in evolving wireless communications standards, such as Long-Term Evolution (LTE) and LTE-Advanced (LTE-A). For example, an LTE or LTE-A system might be an Evolved Universal Terrestrial Radio Access Network (E-UTRAN) and include an E-UTRAN node B (or eNB), a wireless access point, a relay node, or a similar component rather than a traditional base station. These components may be referred-to as an access node.

### BRIEF DESCRIPTION OF THE DRAWINGS

Reference is now made to the following description, taken in connection with the accompanying drawings, wherein like reference numerals may represent like parts.

FIG. 1 is a diagram illustrating a mobile advertising system, according to an embodiment of the present disclosure.

FIG. 2 is a diagram illustrating a mobile advertising system, according to an embodiment of the present disclosure.

FIG. 3 is a diagram illustrating a mobile advertising system, according to an embodiment of the present disclosure.

FIG. 4 is a diagram illustrating use of an XDMS with a MobAd enabler, according to an embodiment of the present disclosure.

FIG. 5 shows an exemplary MobAd MO, according to an embodiment of the present disclosure.

FIG. 6 is a flowchart of a process for defining a MobAd MO, according to an embodiment of the present disclosure.

FIG. 7 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

As used throughout the specification, claims, and Figures, the following acronyms have the following definitions. Unless stated otherwise, all terms are defined by and follow the standards set forth by the Third Generation Partnership Program (3GPP) technical specifications or by the OMA (Open Mobile Alliance).

“Ad” is defined as “Advertising” or “Advertisement”

“AdApp” is defined as “Advertising Application.”

“AdEngine” is defined as “Advertising Engine.”

“AdReqAdd” is defined as “Advertising Request Address.”

“AdServer” is defined as “Advertising Server.”

“AdServerAdd” is defined as “AdServer Access Address.”

“AdServerID” is defined as “AdServer Identification” or “AdServer Identity.”

“AUID” is defined as “Application Usage Identification.”

“App” is defined as “Application.”

“BCAST” is defined as “Broadcast.”

“CAB” is defined as “Converged Address Book.”

“CP” is defined as “Client Provisioning.”

“DCD” is defined as “Dynamic Content Delivery.”

“DM” is defined as “Device Management.”

“HTTP” is defined as “Hypertext Transfer Protocol.”

“ID” is defined as either “Identification” or “Identity.”

“IP” is defined as “Internet Protocol.”

“MA” is defined as “Management Authority.”

“MetRepAdd” is defined as “Metric Reporting Address.”

“MO” is defined as “Management Object.”

“MobAd” is defined as “Mobile Advertising.”

“NotifAdd” is defined as “Notification Address.”

“OMA” is defined as “Open Mobile Alliance.”

“RuleReqAdd” is defined as “Rule Request Address.”

“SchExtURI” is defined as “Schema Extension URI.”

“SP” is defined as “Service Provider.”

“SPID” is defined as either “SP Identification” or “SP Identity.”

“URI” is defined as “Uniform Resource Identifier.”

“XDM” is defined as “XML Document Management.”

“XDMC” is defined as “XDM client.”

“XDMS” is defined as “XML Document Management Server.”

“XML” is defined as “eXtensible Markup Language.”

Definition: As used herein, an “agent” is software or instructions which use an MO for configuration of its services, though an “agent” could be implemented as a purely hardware or firmware component.

The embodiments described herein relate to parameters for configuring or otherwise managing mobile advertising applications. Currently, there is no standard solution or definition of specific configuration parameters to remotely manage a MobAd client based on the OMA DM protocol. The recent increased development activity of MOs has exacerbated this issue. The embodiments described herein address this issue by providing defined sets of configuration parameters, as well as principles for configuring mobile advertising applications.

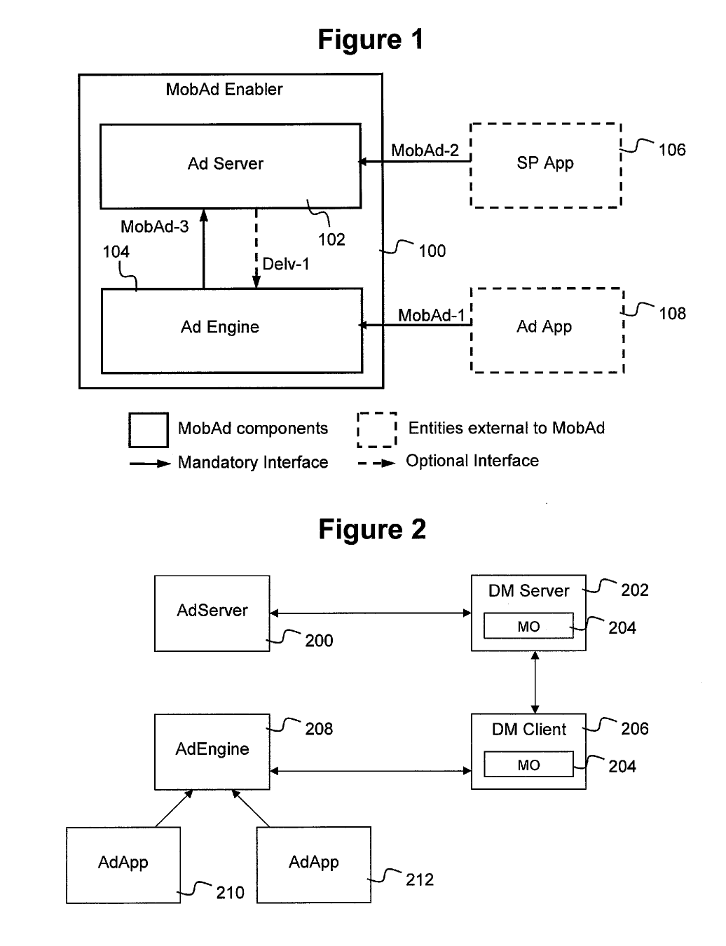

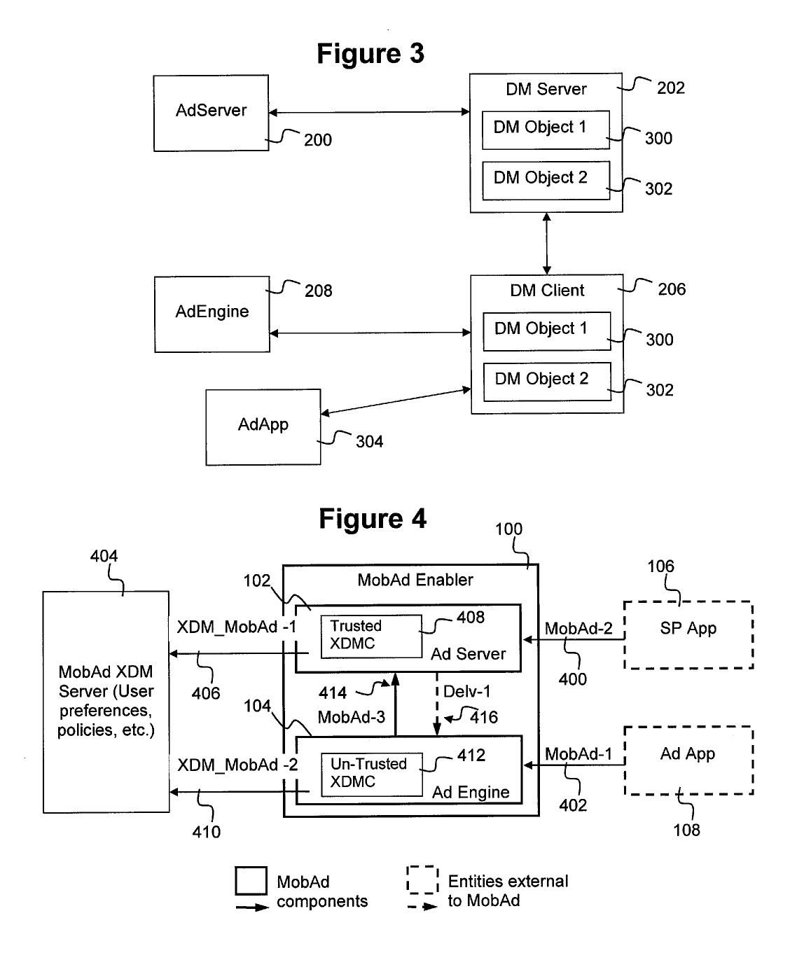

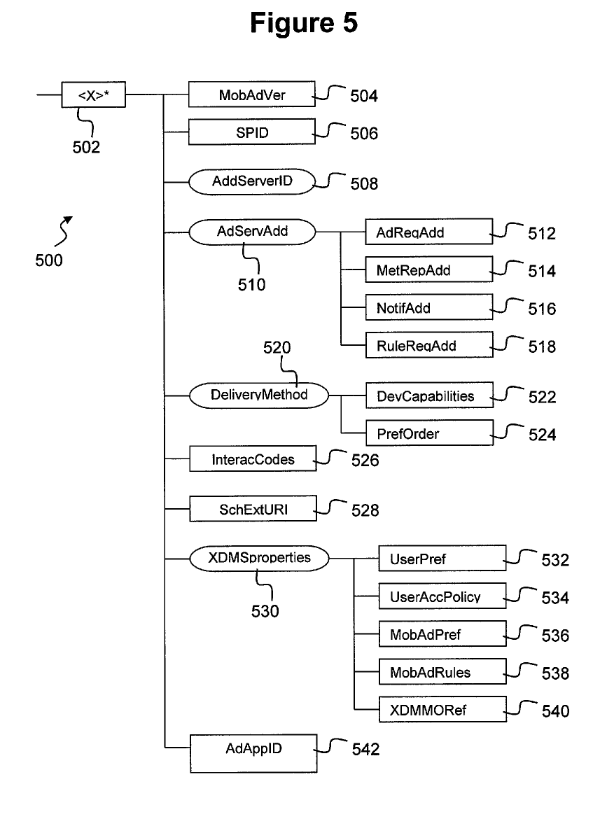

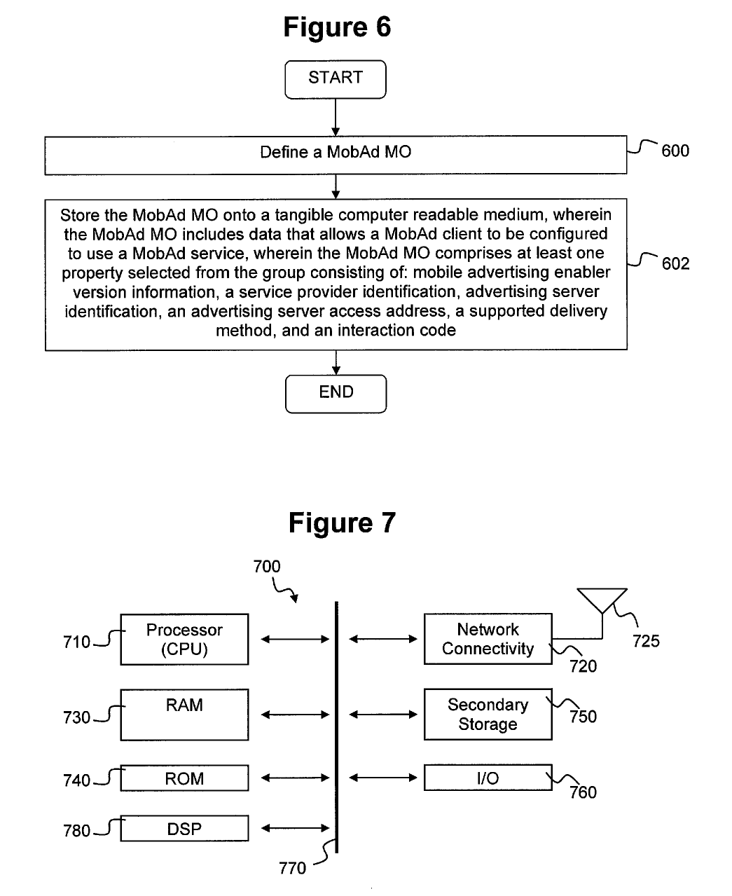

Thus, the embodiments described herein relate to remote management of MobAd clients, such as client-side or device-side applications implementing the functions of an AdEngine, or the functions of an advertising application (AdApp), via the OMA DM protocol, by defining necessary or desired configuration parameters. FIG. 1 describes a mobile advertising system, FIGS. 2 and 3 describe variations on such systems, FIG. 4 describes use of such systems with an XDMS, FIG. 5 describes an exemplary MO—along with the defined sets of configuration parameters—and FIG. 6 is an exemplary flow chart for defining a MobAd MO.

FIG. 1 is a diagram illustrating a mobile advertising system, according to an embodiment of the present disclosure. The various components shown in FIG. 1 may be implemented using one or more processors and/or data processing systems, such as those shown in FIG. 7. Although different components are shown, the various components might be implemented on the same or different data processing systems.

The OMA may specify some advertising metadata, its description and usage, and the enhancement of user profiles with advertising preferences and formats. These metadata may be used to improve user experience and interoperability. The MobAd Enabler 100 is a tool that may provide a consistent architecture so service providers can send to users personalized and interactive advertising services. The MobAd Enabler 100 may also provide service providers with the ability to measure advertisement effectiveness across a range of different types of advertisements of various formats. It should be understood that similar systems, while possibly not compliant with the OMA MobAd specification, may also employ the methods, techniques, etc. described herein.

The MobAd Enabler 100 may include AdServer 102. AdServer 102 may be a MobAd enabler component resident in the network. AdServer 102 may perform a variety of functions. An example function may be ad selection to select the most appropriate ad, ads, or campaigns using contextualization and personalization information, ad metadata, and applicable MobAd rules. Another exemplary function may be an ad delivery function, such as the delivery of ad campaigns performed via pull, push, or broadcast. Another function may be an ad metrics handling function to collect and process ad metrics data. Another example function may be a user or service data management function, such as that used to manage a user's personalization and contextualization data, MobAd rules, user groups, ad channels, among others.

MobAd Enabler 100 may also include AdEngine 104 that communicates with AdServer 102 via one or more interfaces such as the MobAd-3 interface and/or the optional Delv-1 interface, or others as defined by the OMA. The AdEngine 104 may be a MobAd Enabler component resident on the device that performs one or more functions. An example of an AdEngine 104 function may be an ad acquisition and delivery function for acquiring ad(s)/ad campaigns via pull, push or broadcast. Another example of an AdEngine 104 function may be an ad selection function for selecting ads from a cache or a persistent storage. The selection may be based on a number of factors of the AdApp (e.g. requesting AdApp's category/genre, available display area for showing the ad, preferred media type) that is being served by the ad. Another example of an AdEngine 104 function may be an ad metrics handling function for augmenting ad metrics data received from AdApps, validating and reporting metrics data to the AdServer 102. Another example of an AdEngine 104 function may be a user/service/device data handling function for gathering and processing a user's personalization and contextualization data, monitoring and processing device static and/or dynamic status such as a device resource threshold, and applying MobAd rules.

SP App 106 may be an entity that requests and receives ad(s)/ad campaign(s) from the AdServer 102. The SP App 106 may embed these ads or ad campaigns in content that is provided to the user. The SP App 106 may record ad metrics data related to the ad(s) and report ad metrics data to the AdServer 102. The SP App 106 may communicate with the AdServer 102 via an interface, such as the MobAd-2 interface, as shown in FIG. 1.

AdApp 108 may be an entity running on the device that requests and receives ad(s) from AdEngine 104. AdApp 108 may present the ad(s) to the user. AdApp 108 also may report ad metrics data to the AdEngine 104. The AdApp 108 may communicate with the AdEngine 104 via an interface, such as the MobAd-1 interface, as shown in FIG. 1. Note that the various entities, such as but not limited to AdApp 108 and SP 106, may be logical in nature and may be implemented in one or more physical entities (such as computer hardware) as deemed appropriate by a particular implementation.

The MobAd Enabler 100 may include definitions for a global standard for mobile advertising management. The core functionalities of MobAd Enabler 100 include features such as delivering ads to a device and in turn to one or more applications on a device, supporting different interactive mechanisms such as direct ad forwarding, indirect ad forwarding via the AdServer 102, click to bookmark, targeting and personalizing advertisement according to various criteria, and reporting metrics data to the advertising service provider, and others.

Introduction to Management Objects:

Management objects are the entities that may be manipulated by management actions carried over the OMA DM protocol. An MO may be a piece of data, stored in a virtual Device Management (DM) tree. A Management Object may be as small as an integer or may be large and complex like a background picture, screen saver, or security certificate. The OMA DM protocol may be neutral about the content or values of the management objects and may treat the node values as opaque data.

A MO may have a specific utility and be used to provide specific parameters. A DM client may manage an MO on behalf a Management Authority (MA). A device supporting OMA DM may have an embedded OMA DM client.

As OMA DM is becoming more and more popular, there have been more and more MOs created, both standardized and proprietary. Each MO may aim at providing specific parameters to a specific local agent or client. For example, a Converged Address Book (CAB) MO can contain parameters to provision a CAB agent. Currently, there is no standard solution or definition of specific configuration parameters to remotely manage a MobAd client based on OMA DM protocol.

FIG. 2 is a diagram illustrating a mobile advertising system, according to an embodiment of the present disclosure. AdServer 200, which may be similar to AdServer 102 in FIG. 1, communicates with DM Server 202. DM server may configure MO 204 and transmit MO 204 to DM client 206. In turn, DM client may communicate with AdEngine 208, which may be similar to AdEngine 104 in FIG. 1. AdEngine 208 may communicate with one or more AdApps, such as AdApp 210 and AdApp 212. The MO 204 used to configure the AdEngine 208 may contain information to be shared with AdApps 210 and 212.

The embodiments described herein may define the MobAd MO parameters and data schema that may be used to configure the MobAd clients in order to access and consume the MobAd service. The MobAd MO, such as MO 204, may facilitate the management (e.g., configuration, provisioning, etc.) of MobAd parameters. The definition of the MO 204 may be based on the current architecture of the MobAd Enabler. A DM protocol may be supported by MobAd-enabled devices to support remote configuration of the parameters that may be used to configure the MobAd clients.

Multiple configuration options may exist to consume the MobAd service. For example, a MobAd enabled device may use pull, push, or broadcast technology to receive advertisements and to report metrics to an AdServer 200. Similarly, the MobAd client may receive rules and notification via pull or push methods. In addition, the MobAd Client may be configured with specific ad requests, ad responses, and/or metric report schemas which may be used by the MobAd service.

FIG. 3 is a diagram illustrating a mobile advertising system, according to an embodiment of the present disclosure. The mobile advertising system shown in FIG. 3 may be an alternative system to that shown in FIG. 2. Reference numerals in FIG. 3 that are common to FIG. 2 may refer to similar components having similar functions as those components described with respect to FIG. 2.

In the mobile advertising system shown in FIG. 3, two different MOs may be used, MO 300 and MO 302. MO 300 may be used to configure the AdEngine 208, whereas MO 302 may be used to configure AdApps, such as AdApp 304. Thus, in this exemplary embodiment, the MO is used to directly configure advertisement related configuration parameters of the AdApps, such as a CAB client, browser application, feed-reader application, email client, etc., by the AdServer or the AdApp service provider. In FIG. 3, AdServer 200 provides both MOs. However, in another embodiment, AdServer 200 may provide one of the MOs and a second AdServer, or an AdApp service provider, not shown, may provide the other MO. Thus, the second MO may be provided by the same management authority as the one defining the first MO, or the second MO may be provided by another management authority. In still other embodiments, more or fewer AdServers, AdApp service provider, MOs, AdEngines, and/or AdApps may be present. Additionally, the AdApps and the AdEngines shown can be the same or different entities, and it is possible to have one or multiple AdApps.

With respect to either the system shown in FIG. 2 or the system shown in FIG. 3, or both, a variety of parameters may be included in one or more of the MOs. These parameters may be used for remote configuration of MobAd clients using OMA DM techniques. These parameters may be stored in a single MO that would be consumed or used by one entity, such as an AdApp/AdEngine combination shown in FIG. 2. However, these parameters may also be split in two or more MOs, one to be consumed or used by the AdApp and the other by the AdEngine, as shown in FIG. 3. Regardless of how the parameters are divided among one or more MOs, these parameters may be used to provide a standard solution or definition of specific configuration parameters to remotely manage one or more MobAd clients based on an OMA DM protocol.

Eight broad categories of parameters are described below; however, more or fewer parameters may be used and each of these categories of parameters may have one or more different parameters. Neither the order in which these categories of parameters are presented, nor the ordinal number assigned to a category, imply any limitations on the present disclosure. Some parameters might be considered primary or secondary, depending on implementation, and some parameters might be considered mandatory in some implantations or optional in other implementations, again depending on implementation.

A first category of parameters may be a MobAd version, which may be referred to as MobAdVer. The MobAdVer parameter may indicate the MobAd enabler ‘version’ information supported by one or more Ad clients. The version information, such as 1.0, 1.1, or others, may be used by the MobAd client(s) to identify the correct version of the MobAd MO to be used for the configuration

A second category of parameters may be service provider identifications. A SPID may indicate the service provider ID that is hosting the MobAd service or the AdApp service provider hosting the AdApp service. A SPID may be implemented via a unique identifier, in order to avoid conflicts across service providers. The format of a SPID may be any type of character.

A third category of parameters may be an AdServerID. The AdServerID may indicate the AdServer identification for a particular SP provider. The AdServerID may be used to uniquely identify an AdServer within a single service provider domain. The format of the AdServerID may be any type of character.

A fourth category of parameters may be an AdServer access addresses. The AdServerAdd may provide various AdServer network addresses. For example, the AdServerAdd may specify the advertising request address, AdReqAdd, required or desired for retrieving or receiving an advertisement from the AdServer. Another AdServerAdd may specify a metric reporting address, MetRepAdd, required or desired for submitting metrics data reports to the AdServer. Still another AdServerAdd may specify a notification address, NotifAdd, required or desired for submitting notification to the AdServer. Yet another AdServerAdd may specify a rule request address, RuleReqAdd, required or desired for retrieving rules from the AdServer. Note that the same address may be used to for all the requests originating from the AdEngine. The format of AdServerAdd may be a URI, such as a HTTP URI, a specific IP address, or may take some other form that is suitable for representing a network address.

A fifth category of parameters may be a delivery method supported indicator, which might be referred to as DeliveryMethod. The DeliveryMethod indicator may be an indication of the delivery method required or desired for receiving messages from the AdServer. The DeliveryMethod indicator may indicate the device capabilities to use, such as pull, types of push, BCAST, DCD, and others. The DeliveryMethod indicator may also indicate a priority order for communication methods, thereby indicating which communications should be used first.

A sixth category of parameters might be interaction codes, which might be referred to as InteracCodes. InteracCodes may be parameters used by the AdEngine in metrics reporting. These codes and/or the reporting might be shared with the AdApp on the device. The InteracCodes might point to a URI where additional interaction codes could be retrieved. Each supported interactive mechanism or process may be associated with an individual interaction code. For example, some interactions include fetching a URL, while other interactions may be a local or remote action (click to discard, click to indirect forward) that cannot be identified by an URL. These local or remote actions may be identified by corresponding InteracCodes in order that the local or remote actions may be measured. Note that in the case the AdApp and the AdEngine are two separated entities, such as in FIG. 3, the InteracCode set of parameters could be in the AdApp MO only, or could be shared between the AdEngine and AdApp.

A seventh category of parameters might be a schema extension URIs, which might be referred to as SchExtURI. The SchExtURI may be a URI which the AdEngine may use to retrieve various schema extensions specific to an SP. Schema extensions related to AdApp messages may, and in some cases should, be shared with AdApps. Note that instead of a URI, the MO could contain the payload of one or more schemas or the extensions of the one or more schemas.

An eighth category of parameters may be XDMS properties, which may be referred to as XDMSproperties. XDMS properties may provide the required or desired information for the AdServer SP to configure how an AdEngine accesses user preferences and/or policies stored in a given XDMS. The XDMS properties set of parameters may include various sub parameters.

A first sub parameter of XDMS properties may be user preferences, which may be referred to as UserPref. The user preferences parameters may indicate the AUID of the user preferences XDMS. The user preferences parameters may also indicate the URI that may be used to obtain the XML schema of the user preferences XML document stored in the XDMS. Further, it may also include the Aggregation Proxy or Search Proxy address through which the XDMC or XDM Agent may gain access to the User Preference XDMS. The value is of type URI which may represent a HTTP URI.

A second sub parameter of XDMS properties may be a user access policy, which may be referred to as UserAccPolicy. The UserAccPolicy may contain the AUID of the user access policy XDMS. The UserAccPolicy may also contain a URI usable to obtain the XML schema of the user access policy XML document stored in the XDMS. Further, it may also include the Aggregation Proxy or Search Proxy address through which the XDMC or XDM Agent may gain access to the User Access Policy XDMS. The value is of type URI which may represent a HTTP URI.

A third sub parameter of XDMS properties may be MobAd preferences, which may be referred to as MobAdPref. The MobAdPref property may contain the AUID of the MobAd preferences XDMS. The MobAdPref property may also contain a URI usable to obtain the XML schema of the MobAd preferences XML document stored in the XDMS. Further, it may also include the Aggregation Proxy or Search Proxy address through which the XDMC or XDM Agent may gain access to the MobAd preferences XDMS. The value is of type URI which may represent a HTTP URI.

A fourth sub parameter of XDMS properties may be MobAd rules, which may be referred to as MobAdRules. The MobAdRules property may contain the AUID of the MobAd rules. The MobAdRules property may also contain an XML schema of the MobAd rules XML document stored in the XDMS. Further, it may also include the Aggregation Proxy or Search Proxy address through which the XDMC or XDM Agent may gain access to the MobAd rules XDMS. The value is of type URI which may represent a HTTP URI.

A fifth sub parameter of XDMS properties may be XDMMORef, which may contain a reference to the MO associated with the existing XDMC on the device which can be used to access the various MobAd XDMSs. If the dedicated XDMC is used for the MobAd Enabler, this parameter may be optional.

A ninth category of parameters for a MO may be an AdApp identifier list, which may be referred to an AdAppID list. The AdAppID list may be associated with the sp and given an AdServer identifier, or AdServerID. Note that in the case the AdApp and the AdEngine are two separate entities, such as in FIG. 3, the AdAppID list might be in the AdEngine MO only.

FIG. 4 is a diagram illustrating use of an XDMS with a MobAd enabler, according to an embodiment of the present disclosure. The architecture shown in FIG. 4 might include either of the architectures shown in FIG. 2 or FIG. 3, and may be considered a variation on the architecture shown in FIG. 1. Reference numerals in FIG. 4 that are common with reference numerals in FIG. 1 may refer to similar objects having similar properties. Thus, for example, MobAd Enabler 100 includes AdServer 102 and AdEngine 104. SP App 106 communicates with AdServer 102 via the MobAd-2 interface 400. AdApp 108 communicates with AdEngine 104 via the MobAd-1 interface 402.

The OMA XML Document Management Enabler may allow users and other enablers to store and manage XML documents, as described in the OMA XDM specifications. Some of the functionalities provided by the XDM Enabler may be specified in the OMA XDM specifications.

An implementation of the MobAd Enabler 100 functional components, such as AdServer 102 and AdEngine 104, may use the capabilities of the OMA XDM Enabler to retrieve information such as User Profile information, MobAd Enabler preferences, MobAd Enabler rules, selected User Groups information, and other data. Such information is stored in the form of XML documents according to the OMA XDM Enabler. Other SP authorized principals, such as a MobAd Enabler administrator, may use the capabilities of the XDM Enabler to store and manage the information described above.

If included in an implementation, the MobAd Enabler 100 functional components and/or other authorized principals may interact with the OMA XDM Server 404 via the reference points defined by the XDM Enabler, as shown in FIG. 4. Thus, for a particular implementation, OMA XDM Server 404 may include specific OMA XDM reference points. For example, the XDM_MobAd-1 interface 406 may represent the set of interfaces exposed by the XDMS 404 to a XDM Agent 408 on the AdServer 102. Similarly, the XDM_MobAd-2 interface 410 may represent the set of interfaces exposed by the XDMS 404 to an XDMC 412 on the AdEngine 104 enabled device.

Other interfaces may be provided. For example, the MobAd-3 interface 414 and the Delv-1 interface 416 may be used in communications between the AdServer 102 and the AdEngine 104.

Alternatively, the node of the MO may reference a XDM MO if it already exists on the device. For example, when there is already an XDM MO that is used configure the XDM properties, such as a presence or an address book service, and the same XDM client is used to access the documents stored in MobAd XDMSs, this node can simply reference the same XDM MO that is present on the client device. In this case, this node might only define extensions in the MobAd MO that are specific to the MobAd-controlled XDM client.

FIG. 5 shows an exemplary MobAd MO 500 that could be constructed, communicated, generated, defined, configured or otherwise used based on the above parameters, according to an embodiment of the present disclosure. MobAd MO 500 might be used by a MobAd enabler, such as in the architectures shown in FIG. 1 and FIG. 4. MobAd MO 500 may be implemented as a data structure (e.g., tree structure as shown) stored in a tangible or non-transitory memory (e.g., an optical media such as CD or DVD, magnetic media such as tape, or other solid-state storage device known in the art), or may be implemented as firmware.

Interior node <X>* 502 may specify the unique object ID of a MobAd Management Object, or MobAdMO. A purpose of this interior node may be to group together the parameters of a single MobAdMO. The ancestor elements of this node may define the position in the management tree of the MobAdMO object. The MO ID for the MobAdMO may take any convenient form. An example of an MO ID may be urn:oma:mo:oma-mobadmo:1.0, though IDs and ID formats are possible. Interior node <X>* 502 may have the following properties:

### Status: Required

### Occurrence: ZeroOrMore

Format: node
Min. Access Types: Get

The MobAdVer 504 node may be an interior node that specifies the version of the MobAd Enabler. MobAdVer 504 may have the following properties:

### Status: Required

### Occurrence: One

### Format: chr

Min. Access Types: Get

The SPID node 506 may be an interior node that specifies the service provider ID. SPID node 506 may have the following properties:

### Status: Required

### Occurrence: One

### Format: chr

Min. Access Types: Get

The AdServerID node 508 may be an interior node that specifies the AdServer ID for this particular service provider. AdServerID node 508 may have the following properties:

### Status: Required

### Occurrence: One

### Format: chr

Min. Access Types: Get

The AdServerAdd node 510 may be an interior node that specifies the AdServer access address. AdServerAdd node 510 may have the following properties:

### Status: Required

### Occurrence: One

Format: node
Min. Access Types: Get

The AdServerAdd/AdReqAdd node 512 may be a leaf node that specifies the Ad request address for retrieving or receiving an Ad from the AdServer. AdServerAdd/AdReqAdd node 512 may have the following properties:

### Status: Required

### Occurrence: One

### Format: chr

Min. Access Types: Get

The AdServerAdd/MetRepAdd node 514 may be a leaf node that specifies metric reporting addresses for submitting metrics data reports to the AdServer. AdServerAdd/MetRepAdd node 514 may have the following properties:

### Status: Required

### Occurrence: One

### Format: chr

Min. Access Types: Get

The AdServerAdd/NotifAdd node 516 may be a leaf node that specifies the notification addresses for submitting notifications to the AdServer. AdServerAdd/NotifAdd node 516 may have the following properties:

### Status: Required

### Occurrence: One

### Format: chr

Min. Access Types: Get

The AdServerAdd/RuleReqAdd node 518 may be a leaf node that specifies the rule request address for retrieving rules from the AdServer. AdServerAdd/RuleReqAdd node 518 may have the following properties:

### Status: Required

### Occurrence: One

### Format: chr

Min. Access Types: Get

The DeliveryMethod node 520 may be an interior node that specifies the device delivery methods. DeliveryMethod node 520 may have the following properties:

### Status: Required

### Occurrence: One

Format: node
Min. Access Types: Get

The DeliveryMethod/DevCapabilities node 522 may be a leaf node that specifies the delivery methods supported by the device. DeliveryMethod/DevCapabilities node 522 may have the following properties:

### Status: Required

### Occurrence: OneOrMore

### Format: chr

Min. Access Types: Get

The DeliveryMethod/PrefOrder node 524 may be a leaf node that specifies the preferred delivery methods by priority order. DeliveryMethod/PrefOrder node 524 may have the following properties:

### Status: Required

### Occurrence: OneOrMore

### Format: chr

Min. Access Types: Get

The InteracCodes node 526 may be an interior node that specifies the interaction codes, as described above. InteracCodes node 526 may have the following properties:

### Status: Required

### Occurrence: One

### Format: chr

Min. Access Types: Get

The SchExtURI node 528 may be an interior node that specifies a schema extension URI. SchExtURI node 528 may have the following properties:

### Status: Required

### Occurrence: One

### Format: chr

Min. Access Types: Get

The XDMSproperties node 530 may be an interior node that specifies the XDM server properties. XDMSproperties node 530 may have the following properties:

### Status: Optional

### Occurrence: One

Format: node
Min. Access Types: Get

The XDMSproperties/UserPref node 532 may be an interior node that specifies the parameters related to the user preferences XDMS. XDMSproperties/UserPref node 532 may have the following properties:

### Status: Required

### Occurrence: One

Format: node
Min. Access Types: Get

The XDMSproperties/UserAccPolicy node 534 may be an interior node that specifies the parameters related to user access policy XDMS. XDMSproperties/UserAccPolicy node 534 may have the following properties:

### Status: Required

### Occurrence: One

Format: node
Min. Access Types: Get

The XDMSproperties/MobAdPref node 536 may be an interior node that specifies the parameters related to MobAd preferences. XDMSproperties/MobAdPref node 536 may have the following properties:

### Status: Required

### Occurrence: One

Format: node
Min. Access Types: Get

The XDMSproperties/MobAdRules node 538 may be an interior node that specifies the parameters related to MobAd rules. XDMSproperties/MobAdRules node 538 may have the following properties:

### Status: Required

### Occurrence: One

Format: node
Min. Access Types: Get

The XDMSproperties/XDMMORef node 540 may be a leaf node that contains a reference to an existing XDM MO which is used to access MobAd XDMSs. XDMSproperties/XDMMO node 540 may have the following properties:

### Status: Optional

### Occurrence: One

### Format: chr

Min. Access Types: Get

The AddAppID node 542 may be an interior node that specifies the AdApp identifier list associated with the service provider and given AdServerID. AddAppID node 540 may have the following properties:

### Status: Required

### Occurrence: One

### Format: chr

Min. Access Types: Get

The MO shown in FIG. 5 is exemplary only, as other MOs or MO organizational schemes may be used. For example, another organization of a single MO could be structuring per shared parameters or AdEngine only parameters or AdApp only parameters. In the case of a double MO, the structure could be split with shared parameters being replicated in both MOs, with the specific parameters for each as described in the list above. In another embodiment, the AdServerAddress or AdServerAddresses in the first and second MOs may point to different AdServers. The AdServerAddress in the first MO could be considered as the default AdServer.

Furthermore, some of the parameters described above might be applicable only to some types of MOs, in some implementations though not necessarily in others. For example, a MO for an AdApp might only contain the parameters MobAdVer, InteracCodes, and SchExtURI, described above. A MO for an AdEngine might contain all of the parameters described above, except for the InteracCodes. A MO containing information for both an AdEngine and an AdApp might contain all of the parameters described above.

FIG. 6 is a flowchart of a process for using a MobAd MO, according to an embodiment of the present disclosure. The parameters described with respect to FIG. 6 may apply to FIG. 5 in the context of FIGS. 1 through 4.

The process begins as a MobAd MO is defined (block 600). The MobAd MO is then stored (block 602) onto a computer readable medium which may be tangible or otherwise non-transitory, wherein the MobAd MO includes data that allows a MobAd client to be configured to use a MobAd service, wherein the MobAd MO comprises at least one property selected from the group consisting of: mobile advertising enabler version information, a service provider identification, advertising server identification, an advertising server access address, a supported delivery method, and an interaction code. The process terminates thereafter.

The UE and other components described above might include processing and other components that alone or in combination are capable of executing instructions or otherwise able to promote the occurrence of the actions described above. FIG. 7 illustrates an example of a system 700 that includes a processing component, such as processor 710, suitable for implementing one or more embodiments disclosed herein. Accordingly, system 700 may be employed to execute one or more of the previously-described entities such as the Ad Server, the Ad Engine, the Ad App, the DM Server, the DM Client, the XDMC and the XDMS. In addition to the processor 710 (which may be referred to as a central processor unit or CPU), the system 700 might include network connectivity devices 720, random access memory (RAM) 730, read only memory (ROM) 740, secondary storage 750, and input/output (I/O) devices 760. These components might communicate with one another via a bus 770. In some cases, some of these components may not be present or may be combined in various combinations with one another or with other components not shown. These components might be located in a single physical entity or in more than one physical entity. Any actions described herein as being taken by the processor 710 might be taken by the processor 710 alone or by the processor 710 in conjunction with one or more components shown or not shown in the drawing, such as a digital signal processor (DSP) 780. Although the DSP 780 is shown as a separate component, the DSP 780 might be incorporated into the processor 710.

The processor 710 executes instructions, codes, computer programs, or scripts that it might access from the network connectivity devices 720, RAM 730, ROM 740, or secondary storage 750 (which might include various disk-based systems such as hard disk, floppy disk, or optical disk). While only one CPU 710 is shown, multiple processors may be present. Thus, while instructions may be discussed as being executed by a processor, the instructions may be executed simultaneously, serially, or otherwise by one or multiple processors. The processor 710 may be implemented as one or more CPU chips.

The network connectivity devices 720 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 720 may enable the processor 710 to communicate with the Internet or one or more telecommunications networks or other networks from which the processor 710 might receive information or to which the processor 710 might output information. The network connectivity devices 720 might also include one or more transceiver components 725 capable of transmitting and/or receiving data wirelessly.

The RAM 730 might be used to store volatile data and perhaps to store instructions that are executed by the processor 710. The ROM 740 is a non-volatile memory device that typically has a smaller memory capacity than the memory capacity of the secondary storage 750. ROM 740 might be used to store instructions and perhaps data that are read during execution of the instructions. Access to both RAM 730 and ROM 740 is typically faster than to secondary storage 750. The secondary storage 750 is typically comprised of one or more disk drives or tape drives and might be used for non-volatile storage of data or as an over-flow data storage device if RAM 730 is not large enough to hold all working data. Secondary storage 750 may be used to store programs that are loaded into RAM 730 when such programs are selected for execution.

The I/O devices 760 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 725 might be considered to be a component of the I/O devices 760 instead of or in addition to being a component of the network connectivity devices 720.

Thus, the embodiments provide for a computer readable medium storing a data structure. The data structure includes mobile advertising management object (MO) data for use configuring a mobile advertising client to use a mobile advertising service. The mobile advertising MO may be preconfigured on a device such as a MS or UE. However, the mobile advertising MO may alternatively or additionally be communicated to a device such as a MS or UE thereby enabling a provider of the mobile advertising service to make or update service configurations (e.g., by adding, deleting or modifying one or more parameter, attribute, setting, etc. related to the mobile advertising service) during service deployment. The mobile advertising MO includes at least one property selected from the group consisting of: mobile advertising enabler version information, a service provider identification, advertising server identification, an advertising server access address, a supported delivery method, and an interaction code.

The embodiments also provide for a processor configured to store a mobile advertising MO onto a computer readable medium. The mobile advertising MO includes at least one property from the group selected from the group consisting of: mobile advertising enabler version information, a service provider identification, advertising server identification, an advertising server access address, a supported delivery method, and an interaction code.

The embodiments further provide for a computer implemented method. A processor stores a mobile advertising management object (MO) onto a computer readable medium. The mobile advertising MO comprises data that allows a mobile advertising client to be configured to use a mobile advertising service, wherein the mobile advertising MO comprises at least one property selected from the group consisting of: mobile advertising enabler version information, a service provider identification, advertising server identification, an advertising server access address, a supported delivery method, and an interaction code. In an embodiment, the processor may define the MO.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer readable medium storing a data structure comprising:
a mobile advertising management object (MO) comprising data for configuring a mobile advertising client to use a mobile advertising service, wherein the mobile advertising MO comprises at least one property selected from the group consisting of: mobile advertising enabler version information, a service provider identification, advertising server identification, an advertising server access address, a supported delivery method, and an interaction code.

2. The computer readable medium of claim 1 wherein the group further consists of: a schema extension uniform resource indicator (URI), an extensible markup language document management server (XDMS) property, and an advertising application identifier.

3. The computer readable medium of claim 2 wherein the XDMS property comprises one or more of the group consisting of: a user preference, a user access policy, a mobile advertising preference, a mobile advertising rule, and an address of an XDMS from which an extensible markup language document management client (XDMC) is required to access one or more documents stored in the XDMS.

4. The computer readable medium of claim 3 wherein the user preference contains at least one of an application user identification of a user preferences XDMS and a URI usable to obtain an extensible markup language (XML) schema of a user preferences XDMS document stored in the XDMS.

5. The computer readable medium of claim 3 wherein the user access policy contains at least one of an application user identification of a user access policy XDMS and a URI usable to obtain an extensible markup language (XML) schema of a user preferences XDMS document stored in the XDMS.

6. The computer readable medium of claim 3 wherein the mobile advertising preference contains at least one of an application user identification of a mobile advertising preferences XDMS and a URI usable to obtain an extensible markup language (XML) schema of a user preferences XDMS document stored in the XDMS.

7. The computer readable medium of claim 3 wherein the mobile advertising rule contains at least one of an application user identification of the mobile advertising rule and a URI usable to obtain an extensible markup language (XML) schema of a user preferences XDMS document stored in the XDMS.

8. The computer readable medium of claim 1 wherein the advertising server access address comprises one or more of a second group consisting of: 1) an advertising request address pointing to an advertising server, 2) a metric reporting address, usable for submitting metrics data reports pointing to an advertising server or a metric server, 3) a notification address, usable for submitting a notification, pointing to an advertising server, and 4) a rule request address, usable for retrieving rules, pointing to an advertising server.

9. The computer readable medium of claim 1 wherein the supported delivery method specifies a preferred delivery method for receiving messages from an advertising server.

10. The computer readable medium of claim 9 wherein the supported delivery method comprises at least one of an indication of device capabilities to use and an indication of a priority order of a plurality of delivery methods.

11. The computer readable medium of claim 1 wherein the MO is split into a first MO and a second MO, with shared parameters being replicated in both the first and second MOs.

12. The computer readable medium of claim 11 wherein a first advertising server address is in the first MO, wherein a second advertising server address is in the second MO, and wherein the first and second advertising server addresses point to different advertising servers.

13. A device comprising:
a processor configured to use a mobile advertising management object (MO), wherein the mobile advertising MO comprises data that allows a mobile advertising client to be configured to use a mobile advertising service, wherein the mobile advertising MO comprises at least one property selected from the group consisting of: mobile advertising enabler version information, a service provider identification, advertising server identification, an advertising server access address, a supported delivery method, and an interaction code.

14. The device of claim 13 wherein the group further consists of: a schema extension uniform resource indicator (URI), an extensible markup language document management server (XDMS) property, and an advertising application identifier.

15. The device of claim 13 wherein the MO is split into a first MO and a second MO, with shared parameters being replicated in both the first and second MOs.

16. The device of claim 15 wherein a first advertising server address is in the first MO, wherein a second advertising server address is in the second MO, and wherein the first and second advertising server addresses point to different advertising servers.

17. A method comprising:
configuring a device with a mobile advertising management object (MO) relative to a mobile advertising service,
wherein the mobile advertising MO comprises at least one property selected from the group consisting of: mobile advertising enabler version information, a service provider identification, advertising server identification, an advertising server access address, a supported delivery method, and an interaction code.

18. The method of claim 17 wherein the group further consists of: a schema extension uniform resource indicator (URI), an extensible markup language document management server (XDMS) property, and an advertising application identifier.

19. The method of claim 17 wherein the MO is split into a first MO and a second MO, with shared parameters being replicated in both the first and second MOs.

20. The method of claim 19 wherein a first advertising server address in the first MO, wherein a second advertising server address is in the second MO, and wherein the first and second advertising server addresses point to different advertising servers.
